(19) United States
(12) Patent Application Publication
(10) Pub. No.: US 2008/0234094 A1
(43) Pub. Date: Sep. 25, 2008

(54) Transistor-Type Universal Driving

(75) Inventors: Nung Jun Tae, North Hamgyong Province (KP); Yong Chol Kim, North Hamgyong Province (KP); Yong Il Tae, North Hamgyong Province (KP)

Correspondence Address: FULWIDER PATTON LLP, HOWARD HUGHES CENTER, 6060 CENTER DRIVE, TENTH FLOOR, LOS ANGELES, CA, 90045, US

(73) Assignee: NUNG JUN TAE, CONGJIN CITY (KP)

(21) Appl. No.: 11/917,605

(22) PCT Filed: Apr. 28, 2006
(86) PCT No.: PCT/KP2006/000008

§ 371 Date: Dec. 14, 2007

(30) Foreign Application Priority Data
Jun. 20, 2005 (KP) KP2005-000132

(51) Int. Cl. F16H 1/36

(52) U.S. Cl. 475/333

(57) ABSTRACT

The present invention relates to the transistor type universal driving which has three shafts as transistor, i.e. driving shaft, driven shaft and control shaft and can provide non-step speed reduction, non-step speed increase, overloading adaptation control, automatic and remote control. The structural character of the transistor type universal driving is that the control shaft is suitably combined to the fixed support point of the speed reducer which contains the fixed support point.

### FIELD OF THE INVENTION

This invention relates to the machinery driving, particularly to the transistor-type universal driving which could provide the non-step speed reduction, non-step increase, load adaptation control and automatic control.

### BACKGROUND OF THE INVENTION

Nowadays, there are various species of the speed reducers, speed increasers and speed changers in machinery driving.

The international patent application PCT/IT01/00640 discloses the multiple-stage planetary speed reducer which is in gear with the cylindrical gear engagement.

The international patent application PCT/KP 2005/000005 discloses the lever-type gear reducer that could provide not only self-braking, but also realize the non-step speed reduction by using the principle of the lever and moment.

The international patent application discloses the ball-wedge speed reducer which uses the principle of force increase at the wedge.

The international patent application WO 242658 discloses mode of the none-step speed changer, equipped with the generator-motor type and planetary motor mode.

The previous machinery driving such as above mentioned driving, carries out only one effect among the two effects of the reduction and increase and furthermore could not carry out the two functions of the positive non-step speed reduction and non-step speed increase.

In the case of the speed reducer, it carries out speed reduction only and once it is designed and manufactured, ratio could not be arbitrary regulated and furthermore difficult to provide the non-step control, load adaptation control, automatic control and the precision grade of the rotation, in the demand of nano-technology.

In the case of the speed changers, the process of gearing is not so simple and it is carried out through several processes.

In the case of the non-step automatic speed changer, it is not positive gearing and structurally complicated and is difficult to provide the adaptation control following to the load, automatic control, remote control and high precision grade of the rotation.

### SUMMARY OF THE INVENTION

The object of the invention is to provide the transistor-type universal driving which has simple structure and high efficiency and which could operate as the non-step speed reducer and speed increaser and could be used as the non-step speed changer, in the vehicles such as car and automobiles and in the industrial machines such as the machine tools etc.

Another object of the invention is to provide the transistor-type universal driving which is able to guarantee high precision grade in the demand of nano-technology, as well as to realize the non-step control, load adaptation control, automatic and remote control.

The structural character of the transistor-type universal driving, according to the invention, is that, it contains three shafts, i.e. the driving, driven and control shafts, as like the transistor, and the speed of the rotation of the driven shaft is increased or reduced by the direction of the rotation and the speed of the rotation of the control shaft.

This kind of universal driving can be made by combining suitably the control shaft to the speed reducer with fixed support point.

The speed reducers with fixed support point are, for example, the speed reducer such as the “lever-type gear reducer” (International patent application PCT/KP 2005/000005 and the “ball-wedge type speed reducer” of the international patent application PCT/KP 2005/000006, and the control shaft could be worm or cylinder gear.

In one embodiment of transistor type universal driving according to the present invention, a transistor type universal driving (lever gear type), combined the worm to the fulcrum gear (the fixed support point) of the said “lever-type gear reducer”, is shown.

In another embodiment of transistor type universal driving according to the present invention, a transistor type universal driving (ball-wedge type”, combined the worm to the guide sleeve (the fixed support point) of the “ball-wedge type speed reducer”, is shown.

The character of the transistor-type universal driving, according to the invention, is to provide the non-step speed reduction or the non-step speed increase by the direction of the rotation and the rotation speed of the control shaft, supposing that the driving shaft as the emitter, the control shaft as the base and the driven shaft as the collector in the transistor.

It is also to guarantee the stop of the rotation of driven shaft, right rotation, left rotation control, non-step control, load adaptation control, remote control, automatic control and the nano-technological precision grade by connecting the operating motor to the control shaft and control device to the operating motor.

In the transistor-type universal driving according to the present invention, the energy, delivered to the driving shaft, gives no effect to the control shaft and gives only to the driven shaft and the energy, delivered to the control shaft, doesn't give influence to the driving shaft and gives only to the driven shaft. That is, it has the same character as the transistor.

The said universal driving can operate the machines with better flexible character than hydraulic driving.

According to the character of the load change of the machines, each time when the load changes occur, impulse of the load change of the leading motor is delivered to the operating motor and thus it makes leading motor to drive always in a certain horsepower by changing the ratio of the speed reduction.

Therefore, this character can lengthen the working life of the motor.

If the universal driving of the present invention is used instead of hydraulic gear in the machines which use hydraulic driving, it can have better character, because of the quickness of the movement.

### BRIEF DESCRIPTION OF THE DRAWINGS

For a fuller understanding of the invention, reference should now be made to the detailed description thereof in conjunction with the accompanying drawings, wherein:

FIG. 1 is the schematic view of the principle of the transistor-type universal driving.

The FIG. 2 shows the structure of the transistor-type universal driving combined the worm to the fulcrum gear of the lever-type gear reducer.

The FIG. 3 shows the transistor-type universal driving, combined the worm to the guide sleeve of the ball-wedge type speed reducer.

The FIG. 4 shows the characteristic curve of the speed reduction of the transistor-type universal driving, based on the FIGS. 2 and 3.

The FIG. 5 shows the characteristic curve of the speed increase of the transistor-type universal driving based on the FIGS. 2 and 3.

The FIG. 6 shows the synthetic characteristic curve of the transistor-type universal driving, combined with the FIGS. 4 and 5.

The FIG. 7 is the schematic view about the transistor-type universal driving, be used as the speed changer.

The FIG. 8 is the schematic view about the overload adaptation control, the non-step control and automatic control of the transistor-type universal driving.

### DETAILED DESCRIPTION OF PREFERRED EMBODIMENTS

The FIG. 2 shows the schematic view of the principle of the transistor-type universal driving.

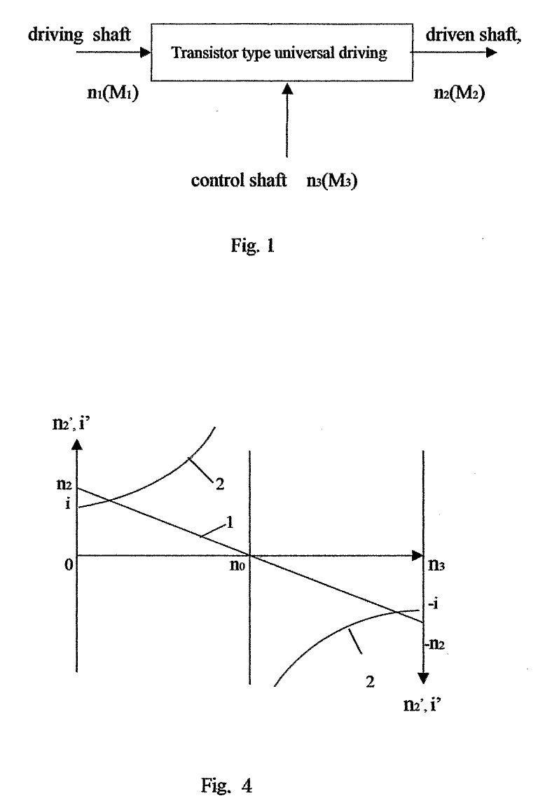

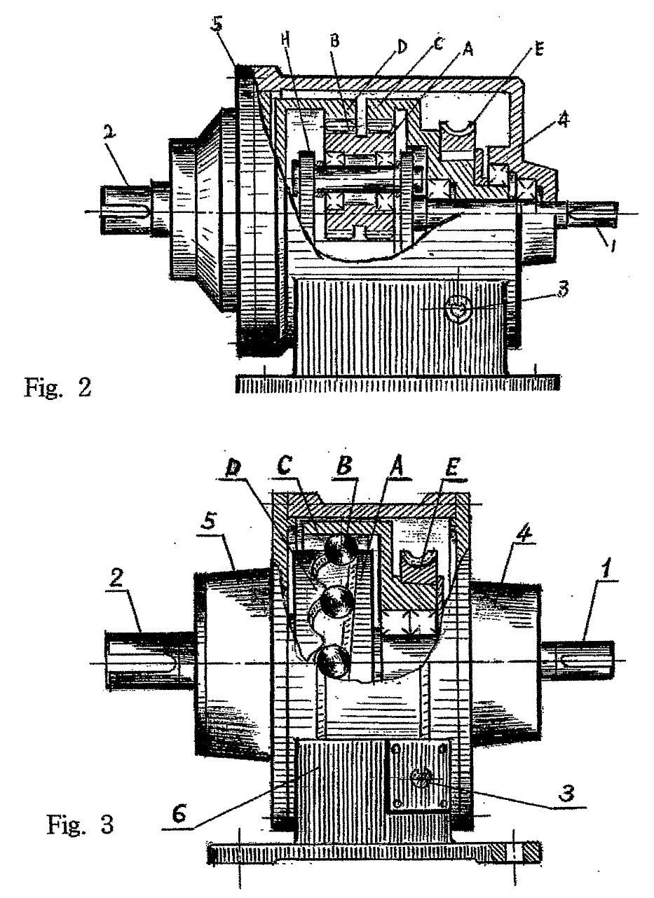

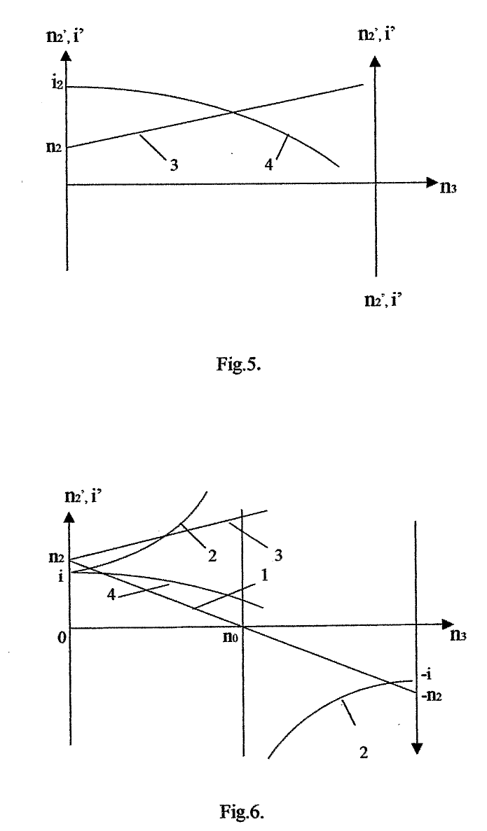

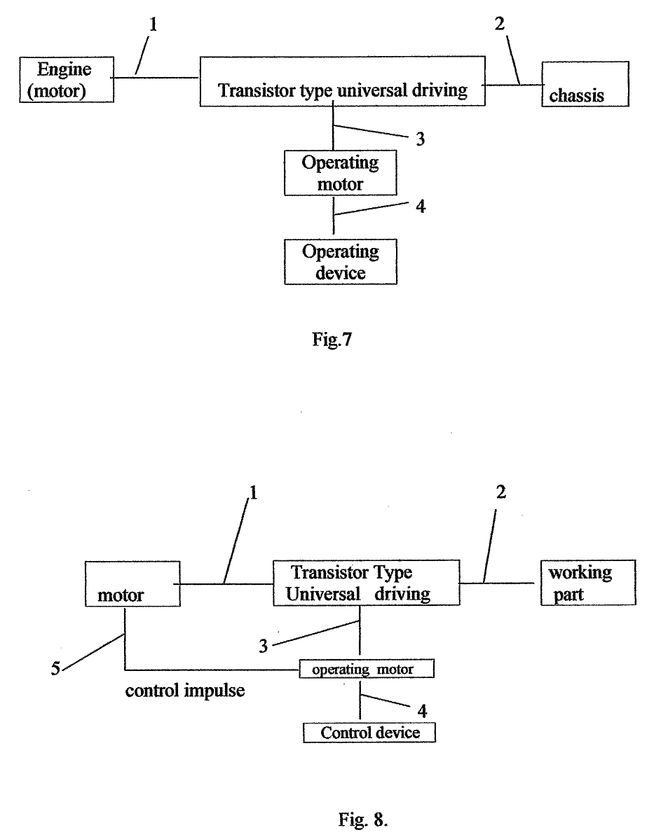

As the FIG. 1 shows, suppose that the driving shaft as the emitter, the driven shaft as the collector, and the control shaft as the base in the transistor.

The dynamic force applied to the driving shaft (n₁, M₁) does not give influence to the control shaft, transfers only to the driven shaft (n₂, M₂) and the dynamic force applied to the control shaft (n₃, M₃) gives no effect to the control shaft, only gives to the driven shaft (n₂, M₂). That is indicated as the direction of the arrow, shown in the FIG. 1.

Considering in the aspect of the horsepower, that is N₁ η₁+N₃ η₂=N₂.

Here, N₁ is the dynamic force of driving shaft, N₃, one of the control shaft and N₂, one of the driven shaft.

And η₁ is the efficiency from driving shaft to the driven shaft and η₂ is the efficiency in the control shaft.

This is in principle the same as the transistor.

That is, it shows the rotation speed (n₂) can be arbitrary controlled according to the rotation speed (n₃) of the control shaft.

The important thing in the transistor-type universal driving, basing on this principle, is that the universal driving comprises so that it has three shafts, such as the driving, driven and control shaft and the rotation speed of the driven shaft can be increased or reduced by the direction of the rotation and rotation speed of the driven shaft.

Such universal driving can be made, suitably combining the control shaft with the speed reducer with fixed support point.

In other words, the speed reducer with fixed support point means the speed reducer that is unable to provide the speed reduction or speed increase, if there is not fixed support point.

The speed reducers with fixed support point are, for example, the speed reducer such as the “lever-type gear reducer” (International patent application PCT/KP 2005/000005 and the

“ball-wedge type speed reducer” of the international patent application PCT/KP 2005/000006, and the control shaft could become for example, worm shaft or cylinder gear.

A transistor-type universal driving (lever gear type), combined the worm to the fulcrum gear (the fixed support point) of the “lever-type speed reducer” of the international patent application PCT/KP 2005/000005 and a transistor-type universal driving (ball-wedge type), combined the worm to the guide sleeve (the fixed support point) of the “ball-wedge type speed reducer” of the international patent application PCT/KP 2006/000006, previously filed by the applicant of present invention are shown in the embodiments of the present invention.

The transistor-type universal driving (lever gear type).

The FIG. 2 shows the structure of the transistor type universal driving, combined the worm (control shaft) to the fulcrum gear (the fixed support point) of the lever type gear reducer.

It is composed of the driving shaft (1), the driven shaft (2), the control shaft (3), body (4), front cover (5), lever-type gear (A,B), fulcrum gear (C), driven shaft (D), worm wheel (E), and setting frame of the lever gear (H).

The lever gear (A,B) is so fixed that to freely rotate as the unity in the setting frame and the setting frame and the driving shaft are so made as the unity or positive assembly that to rotate together when the driving shaft(1) rotates.

The driven gear (D) is so positively fixed with the driven shaft that could rotate together, and that could freely rotate by the support of bearing in the front cover (5).

The fulcrum gear (C) is positively combined with worm wheel (E) and it can freely rotate by the support of bearing between the driving shaft (1) and body (4).

In the lever gear (A,B), A is supported by the fulcrum gear (C) and B makes driven shaft (D) to rotate according to the principle of lever.

The worm wheel (E) is geared with the worm which is united with the control shaft (3) and the fulcrum gear (C) is inhibited so that not to rotate by the worm.

The fulcrum gear (C) could rotate only with turning the control shaft.

In order that the gear engages each other, the self-braking is guaranteed and big rotation of speed reduction can be obtained in the universal driving according to the invention;

in the case of inside engagement such as in FIG. 2, if (Z_{C}−Z_{A})>(Z_{D}−Z_{B}), then the gear is not corrected and if (Z_{C}−Z_{A})>(Z_{D}−Z_{B}) or if (Z_{C}−Z_{A})<(Z_{D}−Z_{B}), then Z_{A}, Z_{B}, Z_{C} and Z_{D} are corrected as + or − in correspondence to the calculated value by the lever principle so that the gear is engaged.

In the case of the outside engagement, if (Z_{A}+Z_{C})>(Z_{B}+Z_{D}), then the gear B and D are corrected as +, and if it is on the contrary, then A and C are corrected as +.

The correction amount must be checked so that the distance between the engagement corresponds with the counted value by the law of the lever.

For instance, in the case of correcting the gear B and D the ratio of the speed reduction i is as follows;

i=Z_{A}(Z_{D}+2ξ_{D})/[(Z_{C}±Z_{A})×(Z_{B}+2ξ_{B}−Z_{A})]

Here, Z_{A}, Z_{B}, Z_{C} and Z_{D} are the tooth numbers of the lever gear A,B fulcrum gear C and the driven gear D and ξ_{D} and ξ_{B} are the correction coefficient of the gear B and D.

The value + of the Z_{C}±Z_{A} in the calculation formula of the speed reducer belongs to the outside engagement and the value—belongs to the inside engagement.

Function of the Non-Step Speed Reducer

The transistor-type universal driving, shown in the FIG. 2, can carry out the function of the non-step speed reducer by the control shaft 3.

When the worm wheel (E) is rotated in the same direction as the diving shaft (1), the lever gear (C) combined with (E) rotates in the same direction, too and at that time, the rotation dislocation of the tooth of the driven shaft(2) by the lever is reduced.

Thus, the rotation speed of the driven shaft 2 would reduce according to the rotation speed of the control shaft 3.

The worm driver is characterized by the self-braking, therefore, the driver preserve the character of the self-braking as it is and gives no effect to the drive efficiency of the speed reducer.

Furthermore, when the driving shaft 1 rotates, the power apply to the fulcrum gear (C) to make the rotation in the same direction, so the worm driving can be operated with the operating motor of low-horsepower.

At that time, the rotation speed of the driving shaft is as follows; n₂′=n₂−k n₃ r/min and the rotation of the speed reduction is i=n₁/(n₂−k n₃): n₁ is the rotation speed of the driving shaft, n₂ is the rotation speed of driven shaft and n₃ is the rotation speed of the control shaft. k is the amplification coefficient and it can be decided by the design parameter and the ratio of the worm speed reduction.

As like the transistor, the amplification ration, H=(n₂−k n₃)/n₁

The transistor-type universal driving is characterized by the amplification coefficient and the ratio of amplification as like the character of the transistor and in order to increase the capability of the non-step speed reduction, the parameter should be selected so that to make k big.

The characteristic curve of the ratio of speed reduction of the transistor-type universal driving of the FIG. 2 is the same as the FIG. 4.

Following examples are referred in order to consider the characteristic curve, indicating the function of the non-step speed reduction of said transistor type universal driving. When the parameter of the said transistor type universal driving, is i=49, Z_{A}=20, Z_{B}=21, Z_{C}=36, Z_{D}=35, i_{w}=36 and n₁=1740 r/min, n₂′=35.51 if n₃=0 and n₂′=0 if n₃=1305 and n₂′=−35.51, if n₃=2610.

When the characteristic curve is made, the straight line 1 is the rotation speed of the non-step speed reduction and straight line 2 is the changing curve of the speed reduction ratio.

As the characteristic curve shows, the change of the rotation speed (n₂′) of the driven shaft is linear and curve of the speed reduction ratio (i) is none-linear curve.
Stop, right and left rotation of universal driving

n₃=0˜1305 is the interval of right rotation of driven shaft of the universal driving and n₃−1305˜2610 is the interval of left rotation of driven shaft and at n₃=1305, the driven shaft is stopped.

Such character is good for managing the machines and thus the working life of the driving motor would be lengthen because it is not needed to rotate right or left.

Function of the Non-Step Speed Increase

In the FIG. 2, if the rotation of the control shaft (3) change on the contrary of above mentioned direction of the rotation, that is, the direction of the rotation of fulcrum gear is changed, then the rotation dislocation of the driven shaft is increased, and thus the driven shaft increases in the designed rotation speed.

The rotation speed of the driven shaft is n₂′=n₂+k n₃ r/min and the ratio of the speed increase is i′=n₁ (n₂+k n₃) and the ratio of amplification is H=(n₂+k n₃)/n₁

Its characteristic curve is the same as the FIG. 5 and the curve 3 in the FIG. 5 shows the change of the rotation speed of the driven shaft and the curve 4 shows the character of the speed reduction ratio.

If the FIG. 4 and FIG. 5 is added, the synthetic characteristic curve of the transistor-type universal driving is obtained and is shown in the FIG. 6.

In FIG. 6, 1 shows the character of the speed reduction, 2 shows the character of the rotation of the speed reduction, 3 shows the character of the speed increase and 4 shows the character of ratio of the speed increase.

Precision Grade of the Rotation

In the case the universal driving, designed and made with parameter A_{Z}=21, Z_{B}=36 and Z_{D}=35, requires the rotation speed of driven shaft n_{2=15.102040821} r/min, it could be operate at accurate n₂′=15.102040821 r/min if n₃ is selected as 750 r/min.

And in the necessary of providing the accurate rotation speed of n₂′=55.918367351 r/min in the above design condition when it operates for the increase, the accurate n₂′=55.918367351 r/min could be provided, if it makes operating motor operate at n₃=+750 r/min.

That is, the accurate rotation speed, up to 10⁻⁹ below the decimal point can be provided so it contributes to the development of nano-science and technology.

The Transistor-Type Universal Driving (Ball-Wedge Type)

The transistor-type universal-driving, combined the worm (control shaft) to guide sleeve (the fixed support point) of the ball-wedge type speed reducer.

The FIG. 3 shows the structure of the said universal driver.

This universal driving is composed of the driving shaft (1), driven shaft (2), control shaft (3), front cover (4), back cover (5), body (6), driving-wedge wheel (A), several balls (B), guide sleeve (C), driven-wedge wheel (D) and worm wheel (E).

The driving-wedge wheel (A) is positively fixed to the driving shaft (1) and in the driving shaft(1), the guide sleeve (C) is stood by the bearing support so that to rotate. The worm wheel (E) is so positively fixed to the guide sleeve (C) that it could rotate with the driving shaft as the center with the guide sleeve.

The worm united with the control shaft (3) is geared with worm wheel (E) and thus the guide sleeve (C) could not rotate without the control shaft (3).

The balls are distributed between the driving wedge (A), the driven wedge (D) and the guide sleeve (C).

The driving shaft (1) is stood by the bearing support that it could rotate in the front cover and the driven shaft (2) is positively assembled to the body (6) and back cover (5) by bolt cover.

The fixed driving wedge (A) which is coaxial with the driving shaft is the wedge contour formed as closed ring type.

The driven wedge (D) is that several wedges are formed as closed contour parallel with the driven shaft and several balls are placed between driven wedge (D) and driving wedge (A).

The guide sleeve (C) is situated along the outside perimeter of the said wedge and in the guide sleeve (C), cross grooves of semicircle type which is for guiding the balls, are formed parallel with the driving shaft bigger than as much as one of the said driven wedge.

When the driving shaft rotates, the rotation speed of the driven shaft is n₂=n₁/z and the speed reduction ratio is i=Z.

The Function of the Non-Step Reducer

The transistor-type universal driver, shown in the FIG. 3 could be non-step control by the control shaft (3).

In the FIG. 3, if the worm wheel (E) is rotated in the same direction as the driving shaft, the guide sleeve (C), combined with that, could rotate in the same direction, so the rotation speed of the driven shaft would change according to the rotation speed of the control shaft 3.

The worm driving is characterized by self-braking Land the universal driving preserves the self-braking character as it is and gives no influence to the efficiency of the speed reducer. Furthermore, when the driving shaft rotates, the force causing the rotation in the same direction as the driving shaft, apply to the guide sleeve (C), so the worm driver could be operated with the operating motor of low-horsepower too.

When the control shaft (n₃′) rotates, the rotation speed of the driven shaft (n₂) is as follows; n₂′=n−k n₃ r/min

The ratio of the speed reduction is i=n₁/(n₂−k n₃)

Here, n₃ is the rotation speed of the control shaft, k is the amplification coefficient and amplification ratio is H=(n₂−k n₃)/n₁

This universal driving is characterized of the amplification coefficient k and amplification ratio H, as like character of the transistor, and in order to raise the capability of the non-step speed reduction, the parameter should be selected that the value of amplification coefficient k should be great.

The characteristic curve of the speed reduction of said universal driving is the same as the FIG. 4.

To consider the characteristic curve of the speed reduction, following examples are referred. In the case the parameter, designed according to the present invention are i=7, Z=7, i_{w}=8, n₁=1740;

If n₃=0 then n_{2=248.57}, and if n₃=2320, then n₂₌₀ and if n₃=4640 then n₂=−248.57. In characteristic curve of FIG. 4, the straight line 1 shows the rotation speed of driven shaft and the curve 2 is the change curve of reduction ratio.

As shown in characteristic curve, the change of rotation speed of the driven shaft is linear and the change curve of the ratio of speed reduction is non-linear curve.

Stop, Right and Left Rotation of the Reducer

The driven shaft rotates in right direction in the interval of n₃=0˜2320 and in left direction in the interval of n₃=1320˜2640. At n₃=2320 the driven shaft is stopped.

This character is very good character for the operation of the machine and the working life of the driving motor is longer because the right and left rotation of the driving motor do not need.

Function of Non-Step Speed Increaser

If the rotation of rotation of the control shaft (3) are changed to reversed direction of the above rotation i.e the direction of the rotation of guide sleeve is changed, the said universal driving operates as the speed increaser in designed rotation speed.

Here, the rotation speed of the driven shaft is n₂′=n₂+k n₃ r/min, and the ratio of the speed increase is i=n₁/(n₂+k n₃) and the ratio of the speed amplification is H=(n₂+k n₃)/n₁.

Its characteristic curve is the same as FIG. 5.

In FIGS. 5 and 3 shows the change of the rotation speed and the curve 4 is the ratio of the speed increase.

If FIG. 4 and FIG. 5 are added, it shows the synthetic characteristic curve of said transistor-type universal driving and it is the same such as the FIG. 6.

In the FIG. 6, 1 shows the character of the speed reduction and, 2 shows the character of the ratio of speed reduction, 3 shows the character of the speed increase and 4 shows the character of the ratio of speed increase.

Precision Grade of the Rotation

In case the rotation speed of the driven shaft, n₂′=40.789267835 r/min is required in said universal driving which is designed for the parameter, Z=7, i=7, i_{w}=8, n₁=1740 r/min, then the universal driving can operate at precise n₂′=40.789267835 r/min if n₃ is selected as 1939.3 r/min.

That is, the precise rotation can be provided up to 10⁻⁹ below the decimals and therefore, it can contribute to nano-technical, high science and technological development.

The non-step control speed changer

The transistor-type universal driving can be used in vehicles such as automobile, car, etc and in various kind of industrial machines, such as the machine tool.

FIG. 7 shows its schematic view of the principle

In FIG. 7, 1 is driving shaft, 2 is driven shaft, 3 is the control shaft and 4 is the control line.

In FIG. 7, the driving motor or organ of the vehicles, is connected to 1, the chassis of vehicles or working tool of the machine tool is connected to 2, and operating motor is connected to 3.

The operating motor is connected to the control device through the control line 4, and thus the non-step control of the speed changer can be realized smoothly by the control device.

The remote control and automatic control can be carried out also easily.

Overloading adaptation control and the non-step control.

FIG. 8 shows the schematic view of the principle for the overloading adaptation control and the non-step control of the transistor type universal driving.

In FIG. 8, 1 is the driving shaft, 2 is driven shaft, 3 is the control shaft 4 and 5 are the control lines.

The driving motor is connected to 2, the operating motor is connected to 3.

The driving motor and the operating motor are combined returned by the control line 5, and the operating motor is connected to the control device by the control line 4.

The various kind and type of the machine equipment generally comprises of; working part—driving-motor.

In such driving, the accident of the motor by the overloading can not be prevented without men's watch and the control.

To avoid such accident, the driving that can provide the overloading adaptation control is required.

This task is performed by the transistor-type universal driving.

By comprising such as in FIG. 8, the transistor-type universal driving can operate the working machines, with more softness character than hydraulic driving, because the electronic movement is faster than fluid speed and the efficiency is by far higher than fluid driving.

As shown in FIG. 8, each time when the load-change of working machine occurs, the impulse of the load-change is delivered to the operating motor, and then the rotation of the driven shaft is reduced in correspondence with the characteristic curve and thus the driving motor operates always only under fixed horsepower.

Therefore, the working life of the motor can be very longer.

In speed control system of the overloading operating motor, the operating motor is in the status of the stop if the operating motor operates in the status of normal load and it begins the rotation with the proportional speed to the overloading horsepower from the moment that the overloading occurs in operating motor.

The operating motor is selected according to the calculation and its horsepower is very lower than the driving motor.

The speed control can be done by amplitude-phase control mode.

Preferred embodiments of the present inventions have now been described; however, the changes will obviously occur to those skilled in the art without departing from the spirit thereof. It is therefore, intended that the invention is to be limited only by the scope of the appended claims.

1. The transistor-type universal driving having driving shaft, driven shaft and control shaft characterized in that the control shaft is suitably combined to the fixed support point of the speed reducer which contains the fixed support point.

2. The transistor-type universal driving according to the claim 1 is characterized in that said speed reducer which contains the fixed support point is lever type gear reducer or the ball-wedge type speed reducer, and said control shaft is worm or cylinder gear.

3. The transistor type universal driving according to the claims 1 or 2 is characterized in that it is the suitable combination of the worm (control shaft) to the fulcrum gear (the fixed support point) of the lever type gear reducer and in particular, is comprised of driving shaft (1), control shaft (2), driven shaft (3), body (4), front cover (5), lever gear (A, B), fulcrum gear (C), the driven gear(D), worm wheel (E), and setting frame for the lever gear wheel (H).

4. The said universal driving according to the claim 3 is characterized in that;
said fulcrum gear (C) is set to the self-braking worm wheel (E) so that it can not be rotated relatively to the driving shaft, but can rotate in necessary cases
the gears are corrected in order that the engaging element of first gear(A) of the lever gear (A,B) is engaged with the fulcrum gear (C) and the engaging element of the second gear (B) is engaged with the driven gear (D).
the lever gear (A,B) is set to setting frame (H) which is united with the driving shaft (1) and setting the worm shaft i.e. control shaft, so that the worm wheel (E) is engaged with the worm.

5. The transistor type universal driving according to the claim 1 or 2 is characterized in that it is the suitable combination of the worm (control shaft) to the guide sleeve (the fixed support point) of the ball-wedge type speed reducer and in particular, is comprised of driving shaft (1), driven shaft (2), control shaft (3), front cover (4), back cover (5), body (6), driving-wedge wheel (A), several balls (3), guide sleeve (C), driven-wedge wheel (D), and the worm wheel(E).

6. The said universal driving according to the claim 5 is characterized in that;
said guide sleeve (C), is set to the self-braking worm wheel (E) so that it can not be rotated relatively to the driving shaft (1), but can rotate in necessary cases.
the several balls (B) are properly placed between driving wedge (A) fixed with the driving shaft (1), driven wedge (D) fixed with driven shaft (2) and the guide sleeve(C).
the guide groove of semicircle groove is formed parallel to the driving shaft (1), so that the balls can be moved freely when the driving wedge (A) rotates.
the bearing is set on the body or cover so that the driving shaft(1) and the driven shaft (2) can move on one shaft.

7. The transistor universal driving according to 1 or 3 or 5 is characterized in that it acts as the non-step speed reducer, if the control shaft is rotated in the same direction of, the driving shaft.

8. The transistor type universal driving according to the claims 1 or 3 or 5 is characterized in that it acts as the non-step speed increaser if the control shaft is rotated in the contrary direction of driving shaft.

9. The transistor type universal driving according to the claims 1 or 3 or 5 is characterized in that it acts as the non-step speed changer if the driving motor is connected to the control shaft, and the operating motor is connected to the control device through the control line.

10. The transistor type universal driving according to the claims 1 or 3 or 5 is characterized in that it acts as the non-step speed changer if the driving motor is connected to the driving shaft, the working part is connected to the driven shaft X the operating motor is connected to the control shaft, and the driving motor is feed-back combination with the operating motor through the control line.
